(19) United States
(12) Patent Application Publication
(10) Pub. No.: US 2011/0217666 A1
(43) Pub. Date: Sep. 8, 2011

(54) HEATED MOUTHPIECE

(75) Inventors: Davy Wong, Fotan (CN); David Colangelo, Tampa, FL (US); Jim Wetzel, Tampa, FL (US)

(73) Assignee: CREATIVE SOURCING & DEVELOPMENT INC., Tampa, FL (US)

(21) Appl. No.: 13/112,051

(22) Filed: May 20, 2011

Related U.S. Application Data
(63) Continuation-in-part of application No. 11/774,695, filed on Jul. 9, 2007, now Pat. No. 7,967,604.

(51) Int. Cl. A61C 19/06

(52) U.S. Cl. 433/32; 433/215

(57) ABSTRACT

A heated mouthpiece includes an upper trough and optionally a lower trough for interfacing with teeth of a user and a heat retention mass that is thermally and physically interfaced to the trough(s). External heat is provided to the heat retention mass from, for example, by immersion in hot water or the mouthpiece is heated in a microwave oven. An oral compound such as a teeth whitening compound is set in the trough(s) and the mouthpiece is inserted into the user's mouth, the trough(s) surround the teeth. Heat from the heat retention mass conducts to the trough(s) while the mouthpiece section is in use within the mouth thereby activating the oral compound.

### CROSS-REFERENCE TO RELATED APPLICATION

This application is a continuation-in-part of U.S. patent application Ser. No 11/774,695, filed Jul. 9, 2007.

### FIELD

This invention relates to the field of mouthpieces and more particularly to a mouthpiece that is heated and retains heat in order to activate a chemical substance placed on it.

### BACKGROUND

Oral devices known as mouthpieces are known in the industry for uses such as protecting the teeth, gums and bones during sporting events. Similar devices are known for performing various functions on the teeth such as whitening the teeth or taking impressions. Impressions are often taken before being fitted for braces, dentures, crowns, bridges, etc.

One such mouthpiece is described in U.S. Pat. No. D539,429 to Wong, which is hereby incorporated by reference. This design patent shows the ornamental layout of one such mouthpiece.

Another mouthpiece is described in U.S. Pat. Application No. 2001/0038998 to Lindquist. This application describes some of the reasons for heating a mouthpiece and includes a heated mouthpiece, but the heated mouthpiece of this application uses electric current or circulation of a heated liquid to perform the heating. Furthermore, even if such mouthpiece were heated by an external source such as a microwave oven, there is no mass within the mouthpiece that would absorb the heat and slowly release the heat to the rest of the mouthpiece.

Certain oral chemical compositions either require heat to work correctly or work better when heat is applied. For example, the action of dental bleaching agents or whiteners is known to accelerate when heated to a temperature greater than 105° F. The mouthpieces of the prior art do not provide for heating the chemical compounds used upon them, and do not provide for sustaining the heat over a useful length of time.

What is needed is a mouthpiece that will accept heat from an external source, will accept heat from a microwave oven and transfer that heat to a substance disposed on the surface of the mouthpiece that contacts the user's teeth.

### SUMMARY

The heated mouthpiece has an upper trough and optionally a lower trough. The troughs interface with teeth of a user. A heat retention mass is thermally and physically interfaced to the trough(s) such that external heat that is provided to the heat retention mass from, for example, by immersion in hot water or the mouthpiece is heated in a microwave oven, is eventually conducted to the trough(s). An oral compound such as a teeth whitening compound is set in the trough(s) and the mouthpiece is inserted into the user's mouth so that the trough(s) surround the user's teeth. Heat from the heat retention mass conducts to the trough(s) while the mouthpiece section is in use within the mouth thereby activating the oral compound.

In one embodiment, a heated mouthpiece is disclosed including a front top wall and a back top wall forming an upper trough, the front top wall placed between an upper lip of a user and upper teeth of the user. The heated mouthpiece also has a heat retention mass comprising a non-metallic material. The heat retention mass is disposed on a front surface of the mouthpiece section and is in thermal contact with the mouthpiece section. The heat retention mass is affixed to a front surface of the mouthpiece section such that the heat retention mass extends outwardly from the front surface of the mouthpiece section in front of front teeth of the user when the mouthpiece section is disposed within the user's mouth. The heat retention mass is heated outside of the mouth of the user and is positioned toward of the user's front teeth when the mouthpiece section is within the user's mouth, at which time the heat retention mass conducts stored heat to the mouthpiece section (trough) and to the user's teeth while the mouthpiece section is within the mouth of the user. The heat retention mass is mounted to the mouthpiece section at a location that extends outward of the mouth, the entire heat retention mass positioned forward of the user's front teeth when the mouthpiece section is within the user's mouth.

In another embodiment, a method of using a heated mouthpiece is disclosed including providing a mouthpiece section having a front top wall and a back top wall forming an upper trough, a front lower wall and a back lower wall forming a lower trough, and a heat retention mass. The heat retention mass is made of a non-metallic material and is situated on a front surface of the mouthpiece section. The heat retention mass is in thermal contact with the mouthpiece section and is affixed to a front surface of the mouthpiece section. The heat retention mass extending outwardly from the front surface of the mouthpiece section in front of front teeth of the user when the mouthpiece section is disposed within the mouth of the user. The method continues with heating the heat retention mass the placing an oral compound in the upper trough and in the lower trough. Next, the mouthpiece section is inserted into the mouth inserting the mouthpiece section into the mouth of the user with the front top wall placed between an upper lip of the user and upper teeth of the user, and the lower front wall placed between a lower lip of the user and lower teeth of the user. Once inserted, heat from the heat retention mass transfers to the mouthpiece section (troughs) and subsequently to the oral compound, heating the oral compound.

In another embodiment, a heated mouthpiece is disclosed including a mouthpiece section that has a front wall connected to a back wall forming a trough, the trough sized to accept and surround the upper teeth of a user. The mouthpiece has a heat retention mass made of a non-metallic material that is thermally and physically interfaced to a front surface of the front wall and extends outwardly away from the front wall. The heat retention mass extending outwardly such that the entire heat retention mass extends from the front surface through the lips of the user and outside of a mouth of the user when the upper teeth are in the trough. External heat provided to the heat retention mass before the mouthpiece is inserted into the mouth of the user conducts from the heat retention mass to the mouthpiece section (troughs) after insertion.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates an isometric view of a heated mouthpiece.

FIG. 2 illustrates a top schematic view of the heated mouthpiece.

FIG. 3 illustrates a front view of the heated mouthpiece.

FIG. 4 illustrates a side view of the heated mouthpiece.

FIG. 5 illustrates a cross sectional view of the heated mouthpiece along line 5-5 of FIG. 1.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

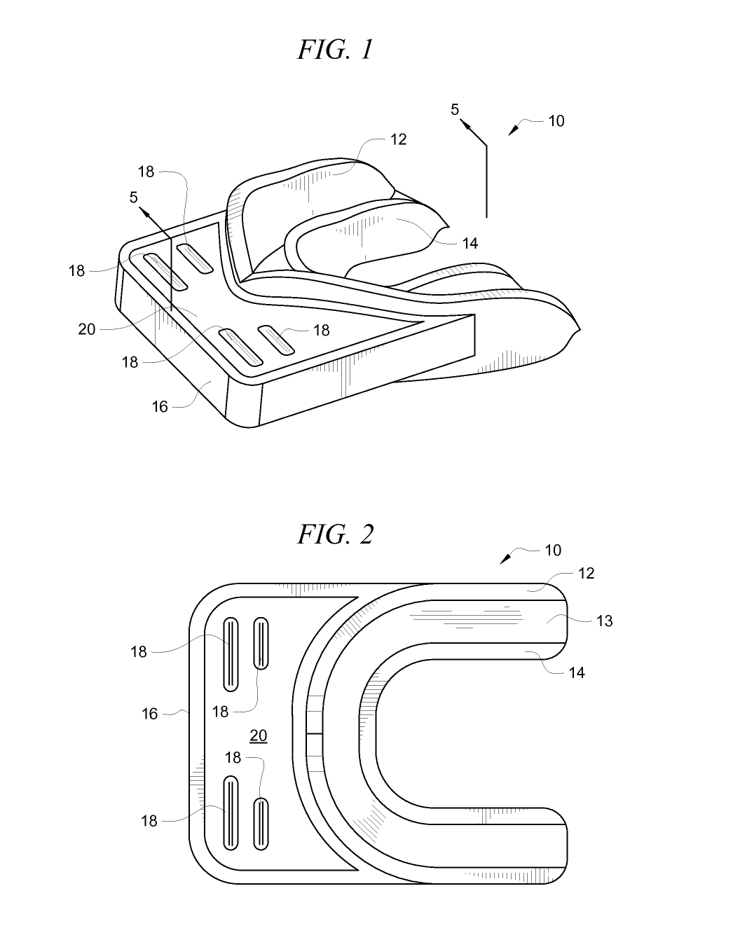

Referring to FIGS. 1 and 2, a heated mouthpiece will be described. The body of the mouthpiece 10 is similar to many mouthpieces, including that described in U.S. Pat. No. D539,429. The body of the mouthpiece 10 has a front top wall 12 and a back top wall 14 (the lower walls of some embodiments are visible in FIG. 5) forming an upper trough 13 for accepting the upper teeth of a user. The front top wall 12 is placed between the upper lip of the user and the upper teeth of the user.

A heat retention mass 20 is disposed in the front surface of the mouthpiece 10 and in some embodiments; the heat retention mass 20 is contained within an encapsulation 16 protecting the heat retention mass 20. In some embodiments, vents 18 are provided to allow heat to enter through the encapsulation 16 and/or to provide a textured grip for inserting and removing the mouthpiece 10 from the user's mouth.

There are several uses for heating the mouthpiece 10, though the mouthpiece 10 of the present invention is in no way limited to these applications. One use is for applying an oral compound such as teeth whitener. By pre-heating the heat retention mass 20, some teeth whiteners perform better or faster. Additionally, the heat provides comfort to the user. Another use for the mouthpiece 10 of the present invention is where the oral compound is for making dental impressions. Often the compound used to take an impression is cold and, due to the length of time required for this compound to set, the cold feeling provides discomfort to the user. By pre-heating the heat retention mass 20, the mouthpiece 10 is subsequently heated by conduction and, therefore, the compound is later heated by conduction. Not only will the compound feel more comfortable to the user, but the heat will decrease the time required for the compound to set.

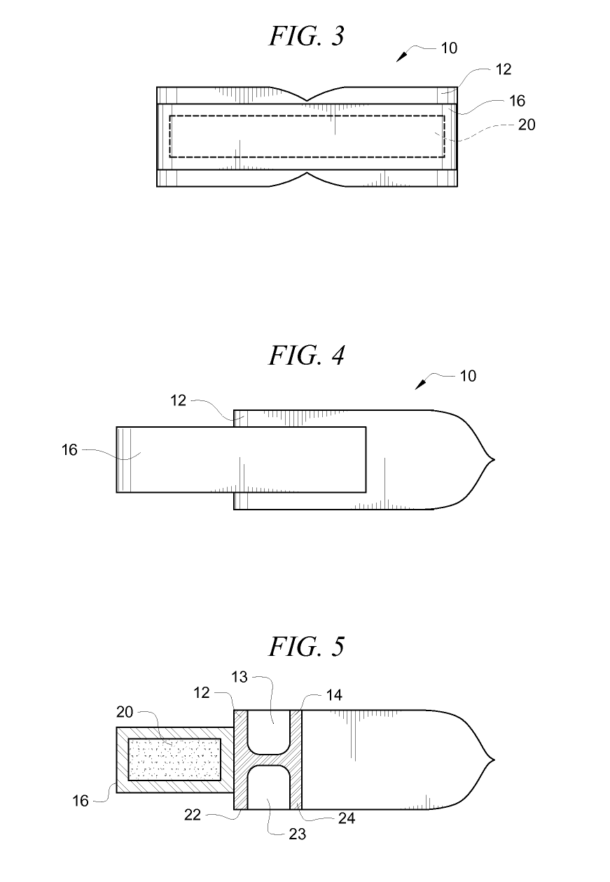

Referring to FIG. 3, a front view of the heated mouthpiece will be described. The heat retention mass 20 is disposed in the front surface of the mouthpiece 10 and in some embodiments; the heat retention mass 20 is contained within an encapsulation 16 protecting the heat retention mass 20. The heat retention mass 20 is forward of the wearer's teeth and extends in a direction outward of the wearer's lips, thereby protruding out of the wearer's mouth when in use.

Referring to FIG. 4, a side view of the present invention will be described. Although the heat retention mass 20 is not limited to any particular size, in the example shown, the heat retention mass 20 and its optional protective cover 16 is slightly shorter than the outside wall 12 and extends outwardly away from the user's mouth.

FIG. 5, a side cross-sectional view of the present invention will be described. In this view, the heat retention mass 20 is shown surrounded by a protective cover or coating 16. The body of the mouthpiece 10 has a mouthpiece section with a front top wall 12 and a back top wall 14 forming an upper trough 13 for accepting the upper teeth of a user. The front top wall 12 is placed between the upper lip of the user and the upper teeth of the user. The mouthpiece section also has a front lower wall 22 and a back lower wall 24 forming a lower trough 23 for accepting the lower teeth of a user. The front lower wall 22 is placed between the upper lip of the user and the upper teeth of the user.

The heat retention mass 20 is made from any suitable material that is capable of being heated while outside of the wearer's mouth. The heat retention mass 20 retains at least some of the heat for distribution after insertion into the user's mouth. In one embodiment, the material is any type of rock or stone including, but not limited to, igneous rock, sedimentary rock, slate, sandstone, shale, lava rock, and marble. Any material that is non-metallic and retains heat is anticipated such as ceramic. Being made of a non- metallic material, heating of the mouthpiece 10 is accomplished by placing the mouthpiece 10 in a warm environment (e.g., hot water, boiling water, oven) until it accepts sufficient heat. By using a non-metallic material for the heat retention mass, the mouthpiece 10 is also suitable for heating in a microwave oven. In still other embodiments, the heat retention mass 20 is a liquid such as water or a gel and to heat the mouthpiece 10, either the mouthpiece 10 is placed in a warm environment (e.g., hot water, boiling water, oven) or the mouthpiece 10 is heated in a microwave oven.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A heated mouthpiece comprising:
a mouthpiece section having a front top wall and a back top wall forming an upper trough, the front top wall placed between an upper lip of a user and upper teeth of the user; and
a heat retention mass comprising a non-metallic material, the heat retention mass disposed on a front surface of the mouthpiece section, the heat retention mass in thermal contact with the mouthpiece section, the heat retention mass affixed to a front surface of the mouthpiece section, the heat retention mass extending outwardly from the front surface of the mouthpiece section in front of front teeth of the user when the mouthpiece section is disposed within the user's mouth;
whereas the heat retention mass is heated outside of the mouth of the user, the heat retention mass being positioned toward of the user's front teeth when the mouthpiece section is within the user's mouth, and the heat retention mass conducts stored heat to the mouthpiece section and to the user's teeth while the mouthpiece section is within the mouth of the user;
wherein the heat retention mass is mounted to the mouthpiece section at a location that extends outward of the mouth, the entire heat retention mass positioned forward of the user's front teeth when the mouthpiece section is within the user's mouth.

2. The heated mouthpiece of claim 1, wherein the heat retention mass is encapsulated within a continuation of the mouthpiece section.

3. The heated mouthpiece of claim 1, wherein the heat retention mass is made from rock.

4. The heated mouthpiece of claim 4, wherein the rock is lava rock.

5. The heated mouthpiece of claim 1, wherein the heat retention mass is made from ceramic.

6. The heated mouthpiece of claim 1, wherein the mouthpiece section includes an upper trough for surrounding a plurality of upper teeth of the mouth and the mouthpiece section includes a lower trough for surrounding a plurality of lower teeth of the mouth.

7. A method of using a heated mouthpiece comprising:
providing a heated mouthpiece, the heated mouthpiece comprising:
a mouthpiece section having a front top wall and a back top wall forming an upper trough and a front lower wall and a back lower wall forming a lower trough; and
a heat retention mass comprising a non- metallic material, the heat retention mass disposed on a front surface of the mouthpiece section, the heat retention mass in thermal contact with the mouthpiece section, the heat retention mass affixed to a front surface of the mouthpiece section, the heat retention mass extending outwardly from the front surface of the mouthpiece section in front of front teeth of the user when the mouthpiece section is disposed within the mouth of the user;
heating the heat retention mass;
placing an oral compound in the upper trough;
placing more of the oral compound in the lower trough; and
inserting the mouthpiece section into the mouth of the user whereas the front top wall is placed between an upper lip of the user and upper teeth of the user, and the lower front wall is placed between a lower lip of the user and lower teeth of the user with the upper teeth in the upper trough and the lower teeth in the lower trough;
whereas heat from the heat retention mass subsequently transfers to the mouthpiece section and subsequently to the oral compound, heating the oral compound.

8. The method of claim 7, wherein the heat retention mass is heated in hot water.

9. The method of claim 7, wherein the heat retention mass is heated in a microwave oven.

10. The method of claim 7, wherein the heat retention mass is encapsulated within a continuation of the mouthpiece section.

11. The method of claim 7, wherein the heat retention mass is made from rock.

12. The method of claim 7, wherein the rock is lava rock.

13. The method of claim 7, wherein the heat retention mass is made from ceramic.

14. A heated mouthpiece comprising:
a mouthpiece section comprising a front wall connected to a back wall forming a trough, the trough sized to accept and surround the upper teeth of a user; and
a heat retention mass made of a non-metallic material, the heat retention mass thermally and physically interfaced to a front surface of the front wall and extending outwardly away from the front wall, the heat retention mass extending outwardly such that the entire heat retention mass extends from the front surface through the lips of the user and outside of a mouth of the user when the upper teeth are in the trough;
whereas external heat provided to the heat retention mass before the mouthpiece is inserted into the mouth of the user conducts from the heat retention mass to the mouthpiece section after insertion.

15. The heated mouthpiece of claim 14, wherein the heat retention mass is encapsulated within a continuation of the mouthpiece section.

16. The heated mouthpiece of claim 14, wherein the heat retention mass is made from rock.

17. The heated mouthpiece of claim 17, wherein the rock is lava rock.

18. The heated mouthpiece of claim 14, wherein the heat retention mass is made from ceramic.

19. The heated mouthpiece of claim 14, wherein the mouthpiece section further includes a lower trough for surrounding a plurality of lower teeth of the mouth of the user.
